(19) United States
(12) Patent Application Publication
(10) Pub. No.: US 2006/0170589 A1
(43) Pub. Date: Aug. 3, 2006

(54) Apparatus and method for maintaining time synchronization in AGPS receiver

(75) Inventors: Chan-Woo Park, Seoul (KR); Sun Choi, Seoul (KR); Ki-Hyun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/340,610

(22) Filed: Jan. 27, 2006

(30) Foreign Application Priority Data
Jan. 28, 2005 (KR) 2005-8177

(51) Int. Cl. G01S 5/14

(52) U.S. Cl. 342/357.02; 342/357.1

(57) ABSTRACT

An apparatus and method are provided for obtaining a location of a CDMA personal portable terminal according to an AGPS scheme. The method includes receiving a Doppler value of a satellite from an AGPS server, receiving a satellite signal and measuring a Doppler value of the satellite by using the received satellite signal, calculating a code frequency bias ψ_{b} by using a difference between the received Doppler value and the measured Doppler value, calculating a code bias φ_{b} in consideration of the calculated code frequency bias ψ_{b} and a search duration, and calculating a pseudorange of the satellite by compensating for the calculated code bias φ_{b}.

### CROSS-REFERENCE TO RELATED APPLICATIONS

This application claims the benefit under 35 U.S.C. § 119(a) of Korean Patent Application No. 10-2005-0008177, entitled “Apparatus And Method For Maintaining Time Synchronization In AGPS Receiver” filed in the Korean Industrial Property Office on Jan. 28, 2005, the entire disclosure of which is hereby incorporated by reference.

### BACKGROUND OF THE INVENTION

1. Field of the Invention

The present invention relates to a Code Division Multiple Access (CDMA) communication system. More particularly, the present invention relates to an apparatus for obtaining an exact position of a receiver which uses a Global Positioning System (GPS) scheme in a synchronous CDMA communication system receiver.

2. Description of the Related Art

Development of current civilization has been accompanied by remarkable developments of personal portable communication, which supports various additional services. Especially, such developments are found in current trends to provide various location information-related services to personal portable terminals, each equipped with a GPS.

Currently, there are a predetermined number of GPS satellites which revolve around the earth along predetermined earth orbits while broadcasting exact ephemeris of themselves together with system time, so that GPS receivers on the earth can determine the locations of the receivers themselves. Each of the GPS receivers calculates relative reception time of GPS signals simultaneously transmitted from at least four GPS satellites, so as to determine exact time and its own location.

It usually takes a relatively long time of, for example, several minutes for a process of location calculation by the GPS receiver to be completed. Especially, as the reception signal intensity becomes weaker, the time required for the calculation rapidly increases. Further, it is difficult to perform the GPS operation for a long time in a small GPS receiver mounted in a portable device having only a limited battery power, including a personal portable terminal such as a mobile phone or a Personal Digital Assistant (PDA). Therefore, some GPS receivers obtain basic information necessary for search (including an approximate code position and Doppler value) from a neighbor server, for example, an Assisted GPS (AGPS). Hereinafter, an operation of the AGPS will be discussed in greater detail.

An AGPS server is a server which is connected to a CDMA network and provides a location confirmation service for a personal portable terminal. The AGPS server includes a reference GPS receiver and an operation unit. The reference GPS receiver continuously traces/monitors each GPS satellite signal and provides information necessary for positioning service for the personal portable terminal and a result of operation of location solution for measured values obtained from the personal portable terminal. The communication protocol between the AGPS server and the personal portable terminal obeys the IS-801 standard. For example, when there is a request for aiding of an acquisition assistance signal from the personal portable terminal, the AGPS transmits a code phase (which serves as a basis for GPS signal search in the vicinity of a base station to which the personal portable terminal belongs), an expected Doppler value, and each search range to the reference GPS receiver for each GPS satellite. Thereafter, when the personal portable terminal transmits a measured value of the GPS signal to the AGPS server, the AGPS server calculates a location solution of the personal portable terminal by using the measured value, and then transmits the calculated location solution to other information processing devices within the personal portable terminal or the network.

In response to the operation of the AGPS server, the GPS receiver of the personal portable terminal requires exact GPS reference time and reference frequency, in order to reduce the time required for GPS signal search and improve reception sensitivity. For example, when the GPS receiver of the personal portable terminal has incorrect GPS reference time and reference frequency, the personal portable terminal must enlarge the signal search range (for example, search range of code and Doppler frequency) by as much as the degree of incorrectness, for signal acquisition. In order to solve such a problem, it is possible to apply time information and frequency information of a synchronous CDMA communication system to the personal portable terminal.

The time information of the personal portable terminal using the CDMA scheme is always exact because it is synchronized with the absolute time of the exact CDMA system while the terminal receives a signal from a base station. Specifically, the time of the personal portable terminal is maintained to be synchronized with the system time with an exactness having an error of less than about 10 microseconds. Further, the personal portable terminal using the CDMA scheme has a reference clock, which is usually a Voltage Controlled Temperature Compensated Crystal Oscillator (VCTCXO) and has a frequency synchronized with the reference frequency of the base station. Therefore, the frequency of the reference clock (VCTCXO) is also maintained very exactly within an error range of about 0.04 ppm. The VCTCXO is a device for oscillating at a fixed frequency by compensating for frequency disturbance according to environmental temperature changes. The VCTCXO enables stable transmission of data signals in a communication apparatus including a personal portable terminal such as a mobile phone.

By using the personal portable terminal using the CDMA scheme, it is possible to acquire an exact GPS reference time which is necessary for the GPS operation of the personal portable terminal, based on the time information of the CDMA system at an initial stage of the AGPS operation. Further, it is possible to acquire an exact reference frequency by sharing the CDMA reference frequency, specifically the VCTCXO, at the initial stage of the AGPS operation. In the AGPS, the operations as described above are called “time aiding” and “frequency aiding,” respectively.

The GPS receiver of the personal portable terminal using the CDMA scheme as described above can determine exact time and location of itself by using at least four satellite signals. However, when only an insufficient number (e.g. one, two, or three) of satellite signals are received in a place (e.g. an indoor area) in which it is difficult to receive the GPS signal, the personal portable terminal using the CDMA scheme can calculate its own location by operating in a hybrid mode, which uses both the insufficient number of satellite signals and the base station signals of the CDMA system.

The hybrid mode location calculation scheme includes the combination of an Advanced Forward Link Trilateration (AFLT) scheme using a Pilot Phase Measurement (PPM) of a CDMA base station signal in order to obtain a location of the personal portable terminal, and a scheme using a GPS pseudorange measurement in order to obtain the location of the personal portable terminal. The hybrid mode location calculation scheme is usually used when only three or fewer GPS signals are received and it is difficult to calculate the location only by the GPS pseudorange. That is, the hybrid scheme is a scheme for calculating the location by using both several GPS satellite signal measurements and several PPMs. Usually, the hybrid scheme calculates the location by receiving one GPS signal and two AFLT measurements, two GPS signals and two AFLT measurements, or two GPS signals and three AFLT measurements.

As noted from the above description, in the case of calculating the location of the personal portable terminal in the hybrid mode, the time synchronization with the CDMA base station has a large influence on the location bias. Specifically, the GPS pseudorange measurement includes a receiver clock bias due to the difference between the GPS time of the personal portable terminal and the actual GPS time, and it is possible to eliminate the receiver clock bias by obtaining exact values of at least four GPS satellite signals in the course of location calculation when at least four GPS satellite signals are received. However, when only three or fewer GPS satellite signals are received and it is impossible to use the hybrid mode, it is impossible to directly obtain the receiver clock bias and such impossibility is directly reflected on the location bias.

The receiver clock bias depends on the accuracy of the time synchronization between the CDMA base station and the personal portable terminal. Therefore, in order to obtain an exact location value when the personal portable terminal operates in a hybrid mode, an exact time synchronization between the CDMA base station and the personal portable terminal is necessary. That is, an apparatus and a method for maintaining an exact time synchronization between the CDMA base station and the personal portable terminal while the personal portable terminal searches and traces the GPS signal within the CDMA system are necessary.

Hereinafter, a structure of a receiver of a personal portable terminal using the GPS as described above will be described.

FIG. 1 is a schematic block diagram of an exemplary receiver of a conventional personal portable terminal using the GPS.

Referring to FIG. 1, the conventional GPS personal portable terminal comprises an antenna, a duplexer 101, a CDMA RF processor 103, a GPS RF processor 105, a reference clock (VCTCXO) 107, a CDMA baseband processor 109, a GPS baseband processor 111, and an AGPS message receiver unit 121. The GPS baseband processor 111 comprises a carrier loop filter 113, a code loop filter 115, a code generator 117, a mixer 118, and a correlator 119.

The conventional personal portable terminal is usually equipped with one antenna and performs both of the two modes, including the GPS function and the CDMA function. Further, the conventional personal portable terminal equipped with a separate antenna for GPS can comprise one reference clock (VCTCXO) 107 which is shared by the CDMA RF processor 103 and the GPS RF processor 105. Therefore, the reference clock (VCTCXO) 107 can be controlled in accordance with the CDMA system frequency when the terminal performs only the general CDMA operation. However, the control of the reference clock 107 can be stopped when the terminal performs the GPS operation.

As shown in FIG. 1, the CDMA RF processor 103 and the GPS RF processor 105 share one reference clock 107. Therefore, at the initial stage of GPS search, the reference time of the GPS baseband processor 111 is synchronized with the CDMA system time. Then, when the GPS function of the portable terminal operates, the control operation for the reference clock 107 by the CDMA signal is stopped. Therefore, when the GPS function of the portable terminal operates, the GPS time of the personal portable terminal (the time of the GPS baseband processor 111) is increased by using the reference frequency synchronized with the CDMA system time, that is, the frequency of the reference clock 107 shared by the CDMA RF processor 103 and the GPS RF processor 105. This process will be discussed in greater detail below with reference to FIG. 2.

FIG. 2 is a graph showing exemplary time bias of a conventional personal portable terminal.

As noted from FIG. 2, in the CDMA operation interval, the CDMA system time of the personal portable terminal has an error value which does not exceed a predetermined level (1 μsec), based on the actual CDMA system time. Further, the CDMA reference frequency of the personal portable terminal also has an error value which does not exceed a predetermined level (0.05 ppm), based on the actual CDMA reference frequency. These error values are maintained below the predetermined levels, respectively, under the control of the CDMA baseband processor 109.

As described above, during the GPS operation of the personal portable terminal, both the reception of the CDMA signals from the CDMA base station and the frequency control by the CDMA signal are stopped. As described above, the error value t_{ERR}_{_{—}}_{I} of the CDMA system time at the initial stage of the GPS search and the error value f_{ERR} of the reference frequency cause differences between the actual GPS time at the end of the GPS search and the GPS time of the personal portable terminal, which is the resultant clock error t_{ERR} of the receiver. Equation (1) below defines the clock error t_{ERR} of the receiver.
t_{ERR}=t_{ERR}_{_{—}}_{I}+t_{ERR}_{_{—}}_{F} (1)

In equation (1), t_{ERR}_{_{—}}_{I} denotes the initial time synchronization error proportional to the accuracy of the GPS reference time which has been synchronized at the initial stage of the GPS search, and t_{ERR}_{_{—}}_{F} denotes the time synchronization drift error which is generated due to the reference clock error when the search of the GPS signal is terminated.

In equation (1), t_{ERR}_{_{—}}_{I} is an error which is generated during a process of synchronizing the reference time of the GPS baseband processor 111 with the CDMA system time at the initial stage of the GPS search and has a magnitude which depends on the accuracy with which the CDMA system time of the personal portable terminal is synchronized with the actual CDMA system time. The magnitude of the error usually has a value which does not exceed 1 μsec.

In equation (1), t_{ERR}_{_{—}}_{F} is a time error which exists at the moment when the frequency control of the reference clock 107 of the personal portable terminal is stopped at the initial stage of the GPS search and has a magnitude depending on the search error, or receiver reference frequency error f_{ERR} and search duration t_{GPS} at the initial stage of the search. That is, as noted from FIG. 2, when the reference frequency, the control of which is stopped during the GPS operation time, has an error, the time of the GPS baseband processor 111 has a time error or bias which gradually increases according to the passage of time. The time error or bias can be expressed by a product obtained by multiplying the total amount of time taken for the search by a ratio of the receiver reference frequency error f_{ERR} with respect to the CDMA reference frequency f as defined by equation (2) below.
t_{ERR}_{_{—}}_{F}=f_{ERR}/f*t_{GPS} (2)

Equation (2) is based on an assumption that the frequency error f_{ERR} is constant during the GPS search duration t_{GPS}. Actually, when the search duration is relatively long, the frequency error f_{ERR} of the reference clock 107, control of which is stopped, gradually changes. However, it is possible to consider that, during the relatively short search duration considered in the present embodiment, the frequency error value f_{ERR} generated at the initial stage of the GPS search is maintained nearly constant until termination of the GPS search.

The errors due to t_{ERR}_{_{—}}_{I} and t_{ERR}_{_{—}}_{F} in equation (1) are used as common errors found as common values in all of the pseudorange measurements of the received satellite signals. The common errors can be completely eliminated from the pseudorange measurements under the condition that at least four satellite signals are simultaneously received.

However, when only one, two, or three satellite signals are received in a place in which it is difficult to receive the GPS signal, the location solution is obtained according to the hybrid scheme. In this case, it is impossible to eliminate the obtained common errors, which have direct influence on the process of obtaining the location solution. Especially, when the search duration is relatively long in an environment with a low signal reception quality, the time synchronization drift error due to the receiver reference frequency error of t_{ERR}_{_{—}}_{F} has a larger value. Therefore, in the case of using the hybrid scheme, it is necessary to eliminate the time synchronization drift error due to the reference frequency error, in order to reduce the clock error.

Accordingly, a need exists for a system and method for obtaining a location of a CDMA personal portable terminal according to an AGPS scheme in which errors are significantly reduced.

### SUMMARY OF THE INVENTION

Accordingly, embodiments of the present invention have been made to solve the above-mentioned and other problems occurring in the prior art, and an object of embodiments of the present invention is to provide an apparatus and method for obtaining a location of a CDMA personal portable terminal according to an AGPS scheme.

It is another object of embodiments of the present invention to provide an apparatus and method for obtaining a location of a CDMA personal portable terminal according to an AGPS scheme, which use a receiver time error in compensation of pseudorange measurements, thereby reducing location error in a hybrid mode location calculation.

It is another object of embodiments of the present invention to provide an apparatus and method which can obtain an exact receiver time error by multiplying a reference frequency error of a receiver by a GPS search duration.

It is another object of embodiments of the present invention to provide an apparatus and method which can obtain a receiver reference frequency error by using a common difference between a reference Doppler frequency value of each satellite received from an AGPS server and a Doppler frequency value of each satellite which a personal portable terminal has obtained by scanning GPS signals.

It is another object of embodiments of the present invention to provide an apparatus and method which precisely measure Doppler frequencies of satellites with a resolution of 1000/n Hz, for example, by using an n-point FFT operation unit, and then obtain an exact reference frequency error by using the measured Doppler frequencies.

In order to accomplish these and other objects, a global positioning apparatus of a personal portable terminal is provided which uses an Assisted Global Positioning System (AGPS) scheme in a Code Division Multiple Access (CDMA) communication system, the global positioning apparatus comprising a reference clock for providing a reference frequency, a CDMA baseband processor for processing signals transmitted to and received from a CDMA base station, a GPS baseband processor for processing GPS baseband signals transmitted to and received from a GPS satellite, an AGPS message receiver unit for receiving a Doppler value of a GPS signal from an AGPS server in order to scan at least one GPS satellite signal, an operation part for performing an operation for the estimation of a location of the personal portable terminal, receiving the GPS signal, and measuring a Doppler value of the GPS signal, and a processing part for calculating a time error by using results of the operation by the operation part and obtaining a pseudorange from the GPS satellite by using the calculated time error.

Preferably, the operation part comprises a memory for storing a correlation result output from the GPS baseband processor and a result of a Fast Fourier Transform (FFT), and an FFT unit for performing the FFT in order to obtain an expected reference Doppler frequency for each satellite.

More preferably, the processing part comprises a signal detector for detecting GPS satellites exceeding a predetermined signal detection threshold by comparing magnitudes of resultant signals of the FFT with the signal detection threshold, a reference frequency error measurer for measuring Doppler frequencies of the GPS satellites detected by the signal detector, measuring Doppler biases which are differences between the measured Doppler frequencies and reference Doppler frequencies estimated for each satellite by the AGPS message receiver unit and generating a code frequency bias by using the measured common Doppler bias, a time error calculator for calculating a time error as a code phase error by using the code frequency bias value, a time error compensator for compensating for the time error calculated by the time error calculator, a signal processor for generating a pseudorange between the personal portable terminal and each satellite by using code phase measurements of signals detected by the signal detector and compensating for the time error input from the time error compensator when generating the pseudorange, and a measured result transmitter for transmitting to the AGPS server, a resultant pseudorange obtained through the compensation of the time error by the signal processor.

In accordance with another aspect of the present invention, a method for global positioning of a personal portable terminal is provided which uses an Assisted Global Positioning System (AGPS) scheme in a Code Division Multiple Access (CDMA) communication system, the method comprising the steps of receiving a Doppler value of a satellite from an AGPS server, receiving a satellite signal and measuring a Doppler value of the satellite by using the received satellite signal, calculating a code frequency bias ψ_{b} by using a difference between the received Doppler value and the measured Doppler value, calculating a code bias φ_{b} in consideration of the calculated code frequency bias ψ_{b} and a search duration, and calculating a pseudorange of the satellite by compensating for the calculated code bias φ_{b}.

It is preferred that the Doppler value obtained by the FFT has a Doppler measurement resolution of 1000/n Hz, which is used in measuring the Doppler frequency, and the reference frequency error is calculated by using the measured Doppler frequency.

### BRIEF DESCRIPTION OF THE DRAWINGS

The above and other objects, features and advantages of embodiments of the present invention will become more apparent from the following detailed description taken in conjunction with the accompanying drawings, in which:

FIG. 1 is a schematic block diagram of an exemplary receiver of a conventional personal portable terminal using a GPS;

FIG. 2 is a graph showing exemplary time bias of a conventional personal portable terminal; and

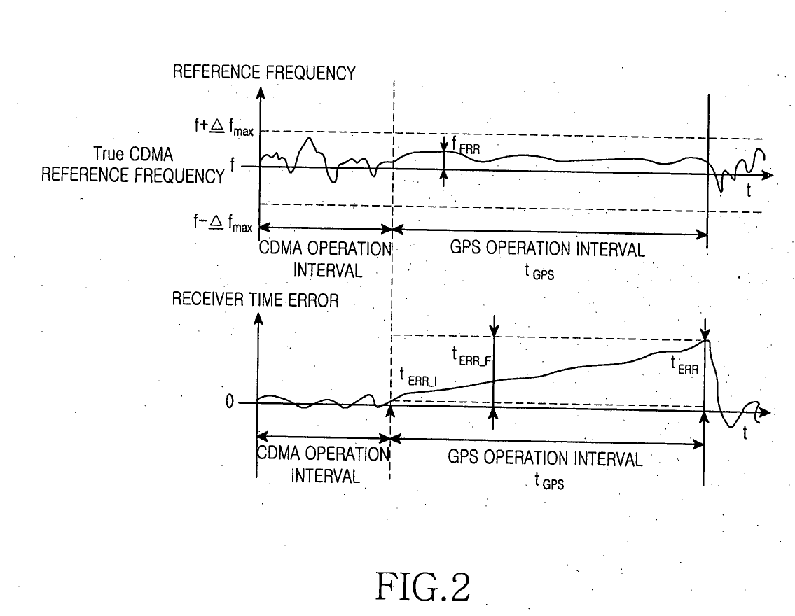

FIG. 3 is a block diagram illustrating an exemplary receiver structure of a personal portable terminal according to an embodiment of the present invention.

Throughout the drawings, like reference numerals will be understood to refer to like parts, components and structures.

### DETAILED DESCRIPTION OF EXEMPLARY EMBODIMENTS

Hereinafter, exemplary embodiments of the present invention will be described with reference to the accompanying drawings. In the following description, a detailed description of known functions and configurations incorporated herein will be omitted when it may make the subject matter of the present invention unclear.

Further, various specific definitions found in the following description are provided to help in the general understanding of embodiments of the present invention, and it should be apparent to those skilled in the art that embodiments of the present invention can be implemented without such definitions.

Embodiments of the present invention provide an apparatus and method which can largely reduce location error of a receiver using a synchronous CDMA system by exactly maintaining the timing synchronization with the CDMA system time when obtaining the location of the receiver by using an Assisted GPS (AGPS) scheme, especially according to a hybrid mode. That is, embodiments of the present invention propose an apparatus and method by which it is possible to maintain exact time synchronization between a personal portable terminal and a CDMA base station while the personal portable terminal searches and traces a GPS signal within a CDMA system.

Further, embodiments of the present invention can improve the system performance by reducing the location error which is generated during hybrid mode calculation of a location of a personal portable terminal using a CDMA system, when the personal portable terminal maintains time synchronization with the CDMA system through frequency aiding and time aiding during obtainment of the location of the receiver according to an AGPS scheme.

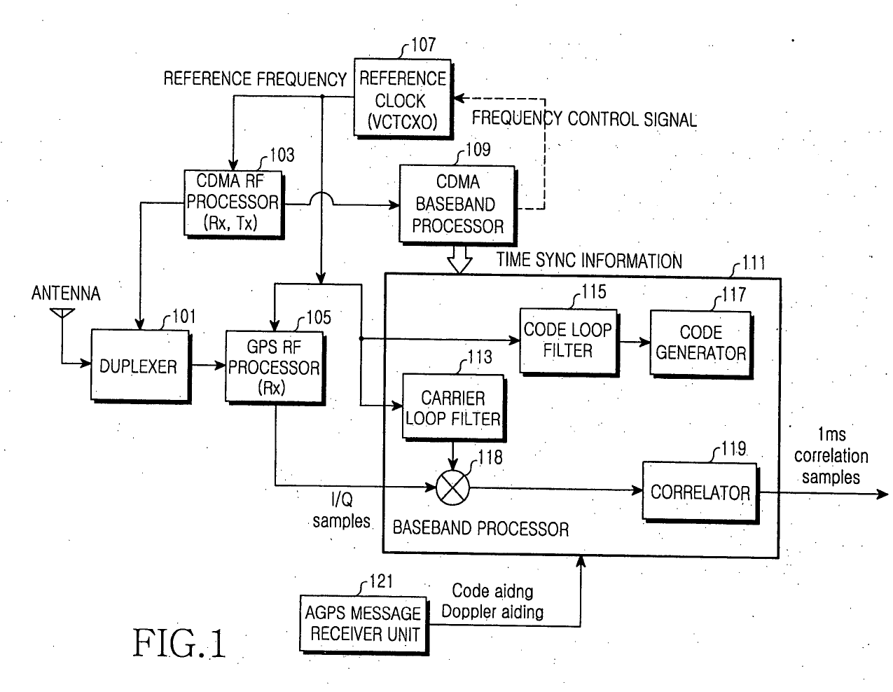

Hereinafter, a method proposed by embodiments of the present invention, which compensates for a time synchronization drift error t_{ERR}_{_{—}}_{F} which has large importance in the resultant clock error t_{ERR}, will be described in greater detail. To this end, elements of FIG. 1, which are further provided in embodiments of the present invention to solve the above and other problems of the prior art will be described with reference to FIG. 1. It is to be understood that embodiments of the present invention are equally applicable to existing hybrid modes wherein one, two, or three satellite signals are received, or any other hybrid mode which is applied when fewer than a desired number of GPS signals are simultaneously transmitted from GPS satellites.

A pseudorange measurement between a personal portable terminal and various GPS satellites refers to a difference between a reference GPS time of the personal portable terminal and the GPS time of measured satellite signals from various GPS satellites, and is expressed as a difference between a code phase value at the GPS time of the personal portable terminal and a code phase value acquired from the satellites. That is, when the GPS time of the personal portable terminal has the receiver time error t_{ERR}, all of the pseudorange measurements acquired from all of the satellites have a common code phase error. However, embodiments of the present invention are not limited thereto.

The common error t_{ERR}_{_{—}}_{F} due to the time synchronization drift error by the reference frequency error is actually expressed as a common error of the code phase value in the receiver internal measurement. Therefore, t_{ERR}_{_{—}}_{F} as defined by equation (2), can be replaced by a code bias type definition as in equation (3) below, wherein the unit has changed from time to code chip. That is, the time error t_{ERR}_{_{—}}_{F} of the personal portable terminal as defined by equation (2) can be replaced by a code bias, which is a GPS code phase value measurement error, as defined by equation (3) below.
φ_{b}=ψ_{b}×t_{GPS} (3)

In equation (3), φ_{b} denotes a common code bias which is units of chips, ψ_{b} denotes a code frequency bias which is in units of chips/second, and t_{GPS} denotes search duration which is in units of seconds.

As noted from equation (3), in order to compensate for the common bias φ_{b}, it is necessary to understand the code frequency bias ψ_{b} which is generated by the frequency error f_{ERR} of the reference clock (VCTCXO).

That is, as shown in FIG. 1, the personal portable terminal scans signals from each GPS satellite by using, together with a Doppler value, a phase of an approximate code which the AGPS message receiver unit 121 has received from an AGPS server. Then, in the personal portable terminal, a local oscillator within the GPS RF processor 105 generates an Intermediate Frequency (IF) by using the reference clock (VCTCXO) 107 which is shared by the CDMA baseband processor 109.

The reference frequency error of the reference clock (VCTCXO) 107 is also found in the intermediate frequency generated by the local oscillator and is called “Local Oscillator (LO) bias.” Due to the local oscillator bias, the Doppler frequency values of the satellites measured by the GPS baseband processor 111 have a common bias.

A Doppler bias D_{b} refers to the difference between a Doppler frequency value obtained from measurement of a GPS satellite signal by the personal portable terminal and a reference Doppler frequency value of AGPS data received from an AGPS server (i.e. an expected frequency value of the GPS satellite signal). The Doppler bias D_{b} is defined by equation (4) below.
D_{b}=D_{ref}−Dₘₑₐₛ (4)

In equation (4), D_{b} denotes the Doppler bias, D_{ref} denotes a reference Doppler frequency received from the AGPS server, and Dₘₑₐₛ denotes a Doppler value measured by the GPS baseband processor. All the parameters in equation (4) are in units of Hertz (Hz).

The code frequency bias ψ_{b} defined by equation (3) can be also obtained by using a transform equation as defined by equation (5) below, which uses the Doppler bias information D_{b} defined by equation (4).
ψ_{b}=D_{b}×k[chips/sec] (5)

In equation (5), k denotes a value obtained by dividing a code frequency by a carrier frequency. For example, k can be expressed as follows.

$$\begin{matrix}k \text{:} ( \begin{matrix}code \\ frequency\end{matrix} / \begin{matrix}carrier \\ frequency\end{matrix} ) = 1.023 [ M chips \text{/} sec ] \text{/} 1.57542 [ GHz ] \\ = 1 \text{/} 1540 [ chips \text{/} sec \text{/} Hz ]\end{matrix}$$

It is possible to obtain the code bias φ_{b} due to the reference frequency error and the time synchronization drift by applying the code frequency bias ψ_{b} obtained by equation (5) to equation (3). Because the code bias is a bias found within the code phase measurements of all satellites, it is possible to eliminate the code bias from the pseudorange measurements from the satellites.

According to embodiments of the present invention as described above, a code frequency bias value as described above is first obtained by using a common difference of satellites between an expected Doppler value received from an AGPS server and Doppler values obtained from actual satellite signals by the personal portable terminal, and a code bias value is then obtained by multiplying the obtained code frequency bias value by a total amount of time taken for the search. Then, by compensating for the obtained code bias value by using the pseudorange of each satellite, it is possible to reduce the location error in the hybrid mode location calculation.

Therefore, according to embodiments of the present invention as described above, it is possible to eliminate the time synchronization drift error resulting from the receiver reference frequency error among the receiver time error increasing when the CDMA personal portable terminal performs the AGPS operation. Such elimination can reduce error in the location of the personal portable terminal, which has been obtained by using the hybrid scheme, thereby improving the system performance.

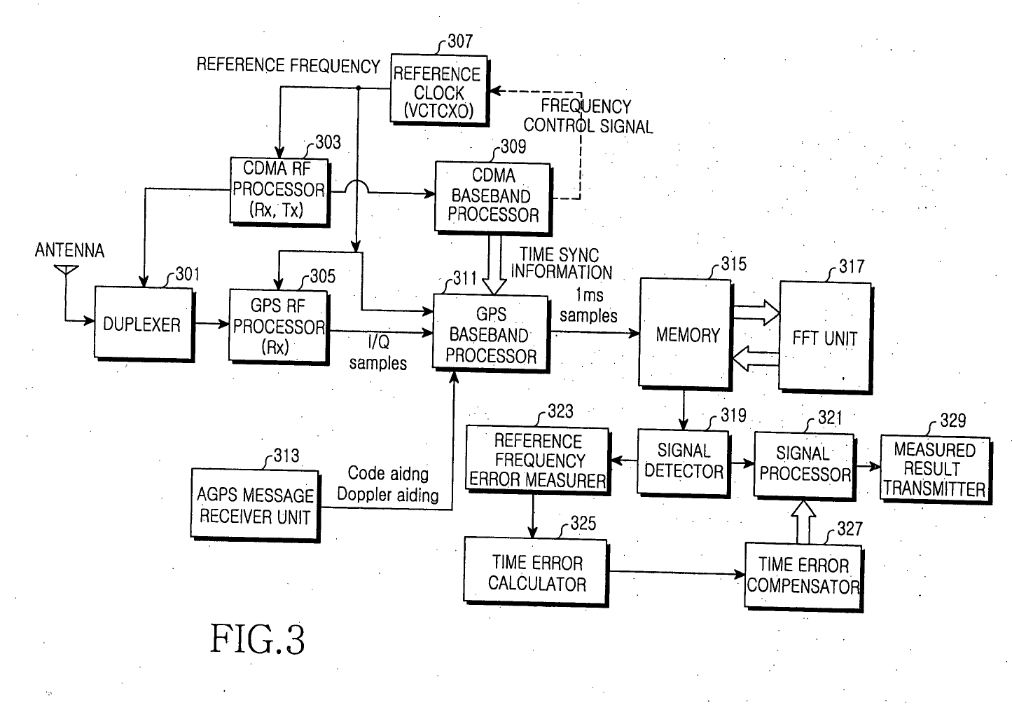

Hereinafter, an exemplary embodiment of an operation according to the present invention will be described with reference to FIG. 3 and FIG. 1.

FIG. 3 is a block diagram illustrating an exemplary receiver structure of a personal portable terminal according to an embodiment of the present invention.

The personal portable terminal shown in FIG. 3 comprises an antenna for data signal transmission/reception with a CDMA base station or a GPS satellite, a duplexer 301 for processing transmitted/received RF signals, a CDMA RF processor 303, a GPS RF processor 305, a reference clock (VCTCXO) 307, a CDMA baseband processor 309 for processing CDMA signals, a carrier loop filter (see FIG. 1), a code loop filter (see FIG. 1), and a correlator (see FIG. 1), a GPS baseband processor 311, and a AGPS message receiver unit 313. The personal portable terminal according to embodiments of the present invention further comprises an operation part and a processing part.

The operation part comprises a memory 315 for storing a correlation result output from the GPS baseband processor 311 and a result of a Fast Fourier Transform (FFT), and an FFT unit 317 for performing the FFT operation.

The processing part is a unit for calculating time error by using the result of the operation by the FFT unit 317 and reflecting the error in the pseudorange measurement, thereby reducing the location error in the hybrid mode. The processing part comprises a signal detector 319, a reference frequency error measurer 323, a time error calculator 325, a time error compensator 327, a signal processor 321, and a measured result transmitter 329.

Hereinafter, an exemplary process of operation by the above-mentioned construction will be described.

First, a 1 ms sample is defined as a result of correlation or accumulation between an actual GPS satellite signal digital samples and receiver PN code replica generated during 1 ms in the GPS baseband processor 311 while the personal portable terminal scans GPS signals by using the Doppler information and codes received by the AGPS message receiver 313.

Based on an assumption that an apparatus according to embodiments of the present invention performs synchronization integration during “n” ms, n number of 1 ms samples are sequentially stored in the memory 315. When all of the n samples have been stored in the memory 315, an n-point FFT is performed on the n 1 ms samples by the FFT unit 317. Thereafter, the result of the FFT is transferred to the memory 315. Then, the result of the FFT has a Doppler measurement resolution of 1000/n Hz, and the signal detector detects satellites which transmit signals having magnitudes exceeding a predetermined signal detection threshold.

It is usually advantageous that the number n of the points in the n-point FFT unit 317 has a large value, for example, 64 or 128 point FFT, but not limited thereto. The larger the number n of the points of the FFT unit 317, the higher the resolution with which the Doppler bias value can be measured (1000/n [Hz] resolution). When it is unable to obtain an exact Doppler bias value, the code phase error value calculated based on the Doppler bias value is invalid. Therefore, it is important to improve the resolution of the FFT unit 317, in order to obtain an exact Doppler bias value.

Next, the reference frequency error measurer 323 measures all Doppler frequencies of satellites exceeding a predetermined signal detection threshold which are detected by the signal detector 319, and the AGPS message receiver unit 313 calculates a difference between an expected reference Doppler frequency for each satellite and the measured frequency. Hereinafter, such a difference is referred to as “Doppler bias.”

The differences between the Doppler frequencies of the satellites and the reference Doppler frequency are determined by two factors as described below. The first factor is a bias of the reference frequency generated by the reference clock (VCTCXO) 307. The bias induces another bias in the frequency of the local oscillator in the GPS RF processor 305 which down-converts the GPS RF signal. In this case, a bias value is found in the Doppler frequency measurements of all the satellites. Next, when a user moves, the user's motion generates a Doppler bias, which differs according to the satellites and can be defined by equation (6) below.
Doppler bias(i)=LO bias+user Doppler(i) (6)

As noted from equation (6), the Doppler bias of a predetermined satellite “i” can be expressed as a sum of the local oscillator bias and a user Doppler value for the satellite i.

However, the user's motion is highly limited in an indoor area in which the GPS signal level is low and the function according to embodiments of the present invention (e.g. the hybrid mode) is mainly used. Therefore, the user Doppler value due to the user's motion can be disregarded.

Therefore, the local bias is obtained by using the difference between the satellite Doppler frequency detected by the signal detector 319 and the Doppler frequency estimated for each satellite by the AGPS message receiver unit 313. The difference has a nearly constant value for all detected satellites. That is, when a plurality of satellites have been detected by the signal detector 319, it is ideal that all the satellites have one common Doppler bias.

Next, by using the measured common Doppler bias, the reference frequency error measurer 323 generates the code frequency bias ψ_{b} as defined by equation (5). Then, the time error calculator 325 calculates the time error in the form of a code phase error φ_{b} as shown in equation (3) by using the code frequency bias ψ_{b}.

Then, the time error calculated in the manner described above is used for compensation of the time error by the time error compensator 327, when the signal processor 321 generates pseudorange between the personal portable terminal and each satellite by using the code phase measurements of the signals detected by the signal detector 319. Finally, the measured result transmitter 329 transmits to the AGPS server the resultant pseudorange from which the time error has been eliminated.

According to embodiments of the present invention as discussed above, a personal portable terminal obtains actual satellite signals based on a received Doppler aiding information value from an AGPS server. Then, the terminal performs an n-point FFT on the satellite signals, thereby acquiring a Doppler value having a resolution of 1000/n [Hz]. Thereafter, a code frequency bias ψ_{b} is calculated by using the difference between the acquired Doppler value and the expected value, and a receiver time error (i.e. code bias φ_{b}) is calculated by multiplying the calculated code frequency bias ψ_{b} by the total amount of time taken for the search. Thereafter, the obtained code bias φ_{b} is eliminated from the pseudorange of each satellite. Through the process described above, embodiments of the present invention can remarkably reduce the location error in the hybrid scheme.

According to the apparatus and method for maintenance of time synchronization in an assisted global positioning system, it is possible to prevent degradation of the correctness of the location determination of a personal portable terminal due to pseudorange error caused by a bias of a reference frequency in the conventional hybrid mode. Further, in a place (such as indoors or a downtown area) in which it is possible to receive only one or two satellite signals due to low signal intensity from the GPS satellites, embodiments of the present invention can achieve more precise positioning.

Moreover, according to embodiments of the present invention, when a CDMA personal portable terminal obtains the location of the terminal in an AGPS scheme, it is possible to obtain an exact receiver time error by multiplying the receiver reference frequency error by the GPS search duration. Then, by compensating the pseudorange measurement for the receiver time error, it is possible to remarkably reduce the location error in the hybrid mode location calculation.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A global positioning apparatus of a personal portable terminal which uses an Assisted Global Positioning System (AGPS) scheme in a Code Division Multiple Access (CDMA) communication system, the global positioning apparatus comprising:
a reference clock for providing a reference frequency;
a CDMA baseband processor for processing signals transmitted to and received from a CDMA base station;
a GPS baseband processor for processing GPS baseband signals transmitted to and received from a GPS satellite;
an AGPS message receiver unit for receiving a Doppler value of a GPS signal from an AGPS server in order to scan at least one GPS satellite signal;
an operation part for performing an operation for an estimation of a location of the personal portable terminal, receiving the GPS signal, and measuring a Doppler value of the GPS signal; and
a processing part for calculating a time error by using results of the operation by the operation part and obtaining a pseudorange from the GPS satellite by using the calculated time error.

2. The global positioning apparatus as claimed in claim 1, wherein the operation part comprises:
a memory for storing a correlation result output from the GPS baseband processor and a result of a Fast Fourier Transform (FFT); and
an FFT unit for performing the FFT in order to obtain an expected reference Doppler frequency for each satellite.

3. The global positioning apparatus as claimed in claim 2, wherein the result of the FFT is stored in the memory and has a Doppler measurement resolution of about 1000/n Hz.

4. The global positioning apparatus as claimed in claim 2, wherein the FFT unit is configured to perform the FFT in order to maintain an accuracy of the Doppler bias value.

5. The global positioning apparatus as claimed in claim 1, wherein the processing part comprises:
a signal detector for detecting GPS satellites exceeding a predetermined signal detection threshold by comparing magnitudes of resultant signals of the FFT with the signal detection threshold;
a reference frequency error measurer for measuring Doppler frequencies of the GPS satellites detected by the signal detector, measuring Doppler biases which are differences between the measured Doppler frequencies and reference Doppler frequencies estimated for each satellite by the AGPS message receiver unit, and generating a code frequency bias by using the measured common Doppler bias;
a time error calculator for calculating a time error as a code phase error by using the code frequency bias value;
a time error compensator for compensating for the time error calculated by the time error calculator;
a signal processor for generating a pseudorange between the personal portable terminal and each satellite by using code phase measurements of signals detected by the signal detector, and compensating for the time error input from the time error compensator when generating the pseudorange; and
a measured result transmitter for transmitting to the AGPS server a resultant pseudorange obtained through compensation of the time error by the signal processor.

6. The global positioning apparatus as claimed in claim 1, wherein the Doppler bias corresponds to a difference between a Doppler frequency of a GPS satellite detected and measured by the signal detector, and a reference Doppler frequency estimated for each satellite by the AGPS message receiver unit.

7. The global positioning apparatus as claimed in claim 5, wherein the Doppler bias is determined by a bias of a reference frequency generated by the reference clock.

8. The global positioning apparatus as claimed in claim 5, wherein the Doppler bias induces a bias in a frequency of a local oscillator within the GPS RF processor which down-converts GPS RF signals.

9. The global positioning apparatus as claimed in claim 5, wherein the Doppler bias is determined by user's motion.

10. The global positioning apparatus as claimed in claim 9, wherein the Doppler bias due to the user's motion for a predetermined satellite i corresponds to a sum of a local oscillator bias and a user Doppler value for the satellite i as defined by the following equation,
Doppler bias(i)=LO bias+user Doppler(i).

11. The global positioning apparatus as claimed in claim 5, wherein the local bias corresponds to a difference between a Doppler frequency of a satellite detected by the signal detector, and a Doppler frequency estimated for each satellite by the AGPS message receiver unit, and the difference is used as one common Doppler bias value by the satellites.

12. The global positioning apparatus as claimed in claim 5, wherein the code frequency bias ψ_{b} is calculated by the following equation,
ψ_{b}=D_{b}×k[chips/sec],
wherein D_{b} denotes the Doppler bias and k denotes a value obtained by dividing a code frequency by a carrier frequency.

13. The global positioning apparatus as claimed in claim 5, wherein the code bias φ_{b} is calculated by the following equation,
φ_{b}=ψ_{b}×t_{GPS},
wherein ψ_{b} denotes a code frequency bias and t_{GPS} denotes search duration.

14. A method for global positioning of a personal portable terminal which uses an Assisted Global Positioning System (AGPS) scheme in a Code Division Multiple Access (CDMA) communication system, the method comprising the steps of:
receiving a Doppler value of a satellite from an AGPS server;
receiving a satellite signal and measuring a Doppler value of the satellite by using the received satellite signal;
calculating a code frequency bias ψ_{b} by using a difference between the received Doppler value and the measured Doppler value;
calculating a code bias φ_{b} in consideration of the calculated code frequency bias ψ_{b} and a search duration; and
calculating a pseudorange of the satellite by compensating for the calculated code bias φ_{b}.

15. The method as claimed in claim 14, wherein the Doppler value obtained by the FFT has a Doppler measurement resolution of about 1000/n Hz, which is used in measuring the Doppler frequency, and the reference frequency error is calculated by using the measured Doppler frequency.

16. The method as claimed in claim 14, further comprising the step of transmitting a pseudorange of the calculated satellite to the AGPS server.

17. The method as claimed in claim 14, wherein the Doppler value obtained by the FFT corresponds to the reference Doppler value estimated for each satellite.

18. The method as claimed in claim 14, wherein a Doppler bias corresponds to a difference between a Doppler frequency measured from a GPS satellite signal and the reference Doppler frequency, and is determined by a bias of a reference frequency generated by the reference clock.

19. The method as claimed in claim 18, wherein the Doppler bias induces a bias in a frequency of a local oscillator.

20. The method as claimed in claim 18, wherein the Doppler bias is determined by user's motion.

21. The method as claimed in claim 20, wherein the Doppler bias due to the user's motion for a predetermined satellite i corresponds to a sum of a local oscillator bias and a user Doppler value for the satellite i as defined by the following equation,
Doppler bias(i)=LO bias+user Doppler(i).

22. The method as claimed in claim 21, wherein the local bias corresponds to a difference between a Doppler frequency of a satellite detected by the signal detector and a Doppler frequency estimated for each satellite by the AGPS message receiver unit, and the difference is used as one common Doppler bias value by the satellites.

23. The method as claimed in claim 14, wherein the code frequency bias ψ_{b} is calculated by the following equation,
ψ_{b}=D_{b}×k[chips/sec],
wherein D_{b} denotes the Doppler bias and k denotes a value obtained by dividing a code frequency by a carrier frequency.

24. The method as claimed in claim 14, wherein the code bias φ_{b} corresponds to a receiver time error.

25. The method as claimed in claim 14, wherein the code bias φ_{b} is calculated by the following equation,
φ_{b}=ψ_{b}×t_{GPS},
wherein ψ_{b} denotes a code frequency bias and t_{GPS} denotes search duration.
